(19) United States
(12) Patent Application Publication
(10) Pub. No.: US 2016/0136586 A1
(43) Pub. Date: May 19, 2016

(54) MEMBRANE AND METHOD OF MANUFACTURING THE SAME

(71) Applicant: AMOGREENTECH CO., LTD., Gimpo-si (KR)

(72) Inventor: Yun Mi SO, Incheon (KR)

(21) Appl. No.: 14/941,933

(22) Filed: Nov. 16, 2015

(30) Foreign Application Priority Data
Nov. 17, 2014 (KR) 10-2014-0160248

(51) Int. Cl. B01D 71/60; B01D 67/00; C02F 1/44; B01D 69/02; B01D 69/10

(52) U.S. Cl. CPC B01D 71/60; B01D 69/02; B01D 69/10; C02F 1/44; B01D 67/0093; B01D 67/009; B01D 67/002; B01D 2325/02; B01D 2325/14; B01D 2325/16; B01D 2325/40; B01D 2323/39

(57) ABSTRACT

Provided are a functional membrane and a method of manufacturing the same, in which the functional membrane has a structure that is formed by accumulating nanofibers that are formed by electrospinning a spinning solution that is produced by mixing a dopamine monomer or polymer, a solvent and a polymer material.

### FIELD OF THE INVENTION

The present invention relates to a membrane, and more particularly, to an ultra-thin functional membrane which can enhance filtering efficiency and improve fouling properties, to thereby filter out heavy metals, bacteria and viruses, and a method of manufacturing the same.

### BACKGROUND OF THE INVENTION

At present, industrialization advances rapidly and the population continues to increase. Therefore, the water shortage has been caused on the Earth everywhere.

97% or more of water present on the Earth is seawater or ice which cannot be directly used and thus is often difficult to be used as industrial and drinking water.

Many studies to solve the lack of water are being conducted, and desalination researches for the desalination of seawater are being actively conducted. Water treatment researches for recycling water previously used as industrial and household water, or for using the groundwater and the surface fresh water as drinking water are also being made continuously.

Meanwhile, a membrane is used as a searator for water treatment, to thus filter out other impurities in water through the membrane.

A polymer membrane which is a type of this membrane is prepared by including: selecting a suitable polymer and a solvent thereby making a polymer solution; casting the polymer solution to be formed into a thin sheet; and depositing the thin sheet as a solid phase, and is used as a filtering purpose.

Korean Patent Application Publication No. 10-2012-0077266 discloses a filtering membrane including: a porous support; and an asymmetric membrane, in which the porous support is composed of thermoplastic polymer nanofiber aggregate with fineness of 50 μm or less, and includes a porous non-woven member with pores by cross-linking the nanofiber aggregate, wherein the sizes of the pores are in a range between 0.003 and 3 μm, and the asymmetric membrane is stacked on the porous support. However, the porous support in the filtering membrane is a non-woven web having a porosity while maintaining the strength, and the asymmetric membrane therein is a reverse osmosis membrane to allow the water to pass through but to prevent ions from passing through. Therefore, the non-woven web alone performs only a function of filtering particles greater than the sizees of the pores contained in the water, and thus the asymmetric membrane that is the reverse osmosis membrane deposited to filter the ions is required.

Therefore, the filtering membrane disclosed in Korean Patent Application Publication No. 10-2012-0077266 has a number of problems such as a thick thickness and the high production cost required, and has a limit to increase a passage flow rate due to the low hydrophilic property.

### SUMMARY OF THE INVENTION

The present invention has been made in view of the points described above, and it is an object of the present invention to provide a functional membrane capable of obtaining excellent hydrophilic property, increasing the filtering efficiency, and improving fouling properties, by

implementing the membrane with a nanofiber web accumulated with nanofibers containing dopamine, and a method of manufacturing the same.

It is another object of the present invention to provide a functional membrane capable of filtering out heavy metals, bacteria and viruses, by forming the membrane with a nanofiber web containing the dopamine and to which a functional group is attached, and a method of manufacturing the same.

It is still another object of the present invention to provide a functional membrane to perform a multi-function with a single-layer structure capable of allowing ultra-thin implementation and reducing production cost, and a method of manufacturing the same.

In order to achieve the above-described objects, according to one embodiment of the present invention, there is provided a functional membrane comprising a nanofiber web that is formed by accumulating nanofibers that are formed by electrospinning a spinning solution that is produced by mixing a dopamine monomer or polymer, a solvent and a polymer material, and is formed of a plurality of pores.

In the functional membrane according to one embodiment of the present invention, functional groups may be attached to the nanofibers, and the functional groups may be negative functional groups or positive functional groups.

Further, in the functional membrane according to one embodiment of the present invention, the diameters of the nanofibers are in a range of 0.1 to 2 μm, and the sizes of the pores may be 3 μm or less.

In addition, the functional membrane according to one embodiment of the present invention may further include a non-woven fabric laminated with the nanofiber web.

In order to achieve one of the above-described objects, according to one embodiment of the present invention, there is provided a method of manufacturing a functional membrane, the method comprising the steps of: preparing a spinning solution that is produced by mixing a dopamine monomer or polymer, a solvent and a polymer material; forming a nanofiber web that is formed by accumulating nanofibers that are formed by electrospinning the spinning solution and is formed of a plurality of pores; and performing a post-treatment process of attaching a functional group to the nanofiber web.

In order to achieve another of the above-described objects, according to one embodiment of the present invention, there is provided a method of manufacturing a functional membrane, the method comprising the steps of: preparing a spinning solution that is produced by mixing a polymer material and a solvent; forming a nanofiber web that is formed by accumulating nanofibers that are formed by electrospinning the spinning solution and is formed of a plurality of pores; coating dopamine on the nanofiber web; and performing a post-treatment process of attaching a functional group to the nanofiber web.

In order to achieve another of the above-described objects, according to one embodiment of the present invention, there is provided a method of manufacturing a functional membrane, the method comprising the steps of: preparing a functional dopamine polymer by performing a process of attaching a functional group to the dopamine polymer; preparing a spinning solution that is produced by mixing the functional dopamine polymer, a solvent and a polymer material; and forming a nanofiber web that is formed by accumulating nanofibers that are formed by electrospinning the spinning solution and is formed of a plurality of pores, wherein a functional group is attached to the nanofiber web.

### Effects of the Invention

According to the present invention, it is advantageous to implement a functional membrane having excellent hydrophilic property with a nanofiber web that is formed by accumulating a nanofiber web containing dopamine.

Since the functional membrane according to the present invention is hydrophilic, a passage flow rate is increased to enhance the filtering efficiency, and improve fouling properties that do not obstruct the pores of the membrane.

According to the present invention, since dopamine is contained in the nanofibers of the nanofiber web constituting the membrane and the functional groups are attached to the nanofibers, it is advantageous to filter out heavy metals, bacteria, and viruses contained in treatment water by allowing the treatment water to pass through.

According to the present invention, it is possible to manufacture a membrane to perform multiple functions in a single layer structure without the need of a laminated structure for addition of functions, to thereby allow ultra-thin implementation and reduce the production cost.

According to the present invention, since the dopamine is contained in nanofibres of the membrane, and the functional group may be introduced into the dopamine, it is advantageous to apply the membrane for various fields such as the water treatment, air filtration, biology, and medical purposes.

### BRIEF DESCRIPTION OF THE DRAWINGS

FIG. 1 is a view for explaining a functional membrane according to a first embodiment of the present invention.

FIG. 2 is a chemical formula of dopamine applied to a functional membrane according to the present invention.

FIG. 3 is a schematic sectional view for explaining a functional membrane according to a second embodiment of the present invention.

FIG. 4 is a schematic view illustrating a state in which functional groups are attached to nanofibers of a functional membrane according to the second embodiment of the present invention.

FIG. 5 is a flowchart view of a first method of manufacturing a functional membrane according to the second embodiment of the present invention.

FIG. 6 is a flowchart view of a second method for manufacturing a functional membrane according to the second embodiment of the present invention.

FIG. 7 is a flowchart view of a third method of manufacturing a functional membrane according to the second embodiment of the present invention.

FIG. 8 is a flowchart view of a fourth method of manufacturing a functional membrane according to the second embodiment of the invention.

### DETAILED DESCRIPTION FOR CARRYING OUT THE INVENTION

Hereinafter, a functional membrane and a method of manufacturing the same according to an embodiment of the present invention will be described in detail with reference to the accompanying drawings.

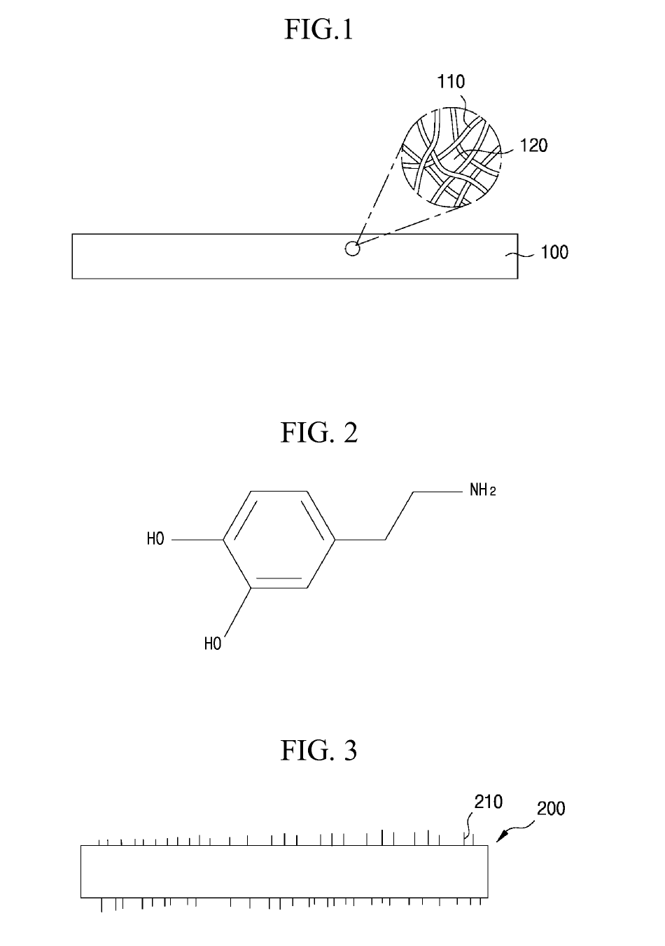

Referring to FIG. 1, a functional membrane 100 according to a first embodiment of the present invention is configured by comprising a nanofiber web that is formed by accumulating nanofibers 110 that are formed by electrospinning a spinning solution that is produced by mixing a dopamine monomer or polymer, a solvent and a polymer material, and is formed of a plurality of pores 120.

Here, dopamine (3, 4-dihydroxyphenylalamine) has a structure that groups such as —NH₂ and —OH are bonded to the benzene ring, as shown in the chemical formula of FIG. 2.

Therefore, the functional membrane 100 according to the first embodiment of the present invention, is a nanofiber web that is formed by accumulating nanofibers containing dopamine, and thus a membrane having excellent hydrophilic property by —OH of the dopamine can be implemented.

Thus, since the functional membrane 100 according to the first embodiment of the present invention has excellent hydrophilic property, a passage flow rate is increased, to enhance the filtering efficiency, and to improve fouling properties that do not obstruct the pores of the membrane.

The functional membrane 100 according to the first embodiment of the present invention may have a unique characteristic by the dopamine contained in the nanofibers 110 constituting the nanofiber web, and may form pores 120 between the nanofibers 110, to thus implement the ultra-fine pore size.

Such a nanofiber web of the functional membrane 100 may be implemented into a structure having a plurality of pores by preparing a spinning solution that is produced by mixing a dopamine monomer or polymer, an electrospinnable polymer material and a solvent at a certain ratio, electrospinning the spinning solution to form nanofibers 110, and accumulating the nanofibers.

A polymer material that may be used in the present invention is a resin that can be melted in an organic solvent for an electrospinning method, and may be formed into nanofibers by the electrospinning method, but is not particularly limited thereto. For example, the polymer material may be any one selected from the group consisting of: polyvinylidene fluoride (PVdF), poly (vinylidene fluoride-co-hexafluoropropylene), perfluoropolymer, polyvinyl chloride or polyvinylidene chloride, and co-polymer thereof; polyethylene glycol derivatives containing at least one of polyethylene glycol dialkylether and polyethylene glycol dialkyl ester; polyoxide containing at least one of poly (oxymethylene-oligo-oxyethylene), polyethylene oxide and polypropylene oxide; polyacrylonitrile co-polymer containing at least one of polyvinyl acetate, poly (vinyl pyrrolidone-vinyl acetate), polystyrene, polystyrene acrylonitrile co-polymer, polyacrylonitrile (PAN), and polyacrylonitrile methyl methacrylate co-polymer; and polymethyl methacrylate, and polymethyl methacrylate co-polymer, and any one combination thereof.

The solvent may be any one or more selected from the group consisting of DMAc (N,N-Dimethyl acetoamide), DMF (N,N-Dimethylformamide), NMP (N-methyl-2-pyrrolidinone), DMSO (dimethyl sulfoxide), THF (tetra-hydrofuran), EC (ethylene carbonate), DEC (diethyl carbonate), DMC (dimethyl carbonate), EMC (ethyl methyl carbonate), PC (propylene carbonate), water, acetic acid, formic acid, chloroform, dichloromethane, acetone and isopropyl alcohol (isopropy).

Then, the number of the pores and the average diameter of pores of the functional membrane 100 can be determined depending on the thickness, and thus membranes having a variety of characteristics may be produced.

The diameters of the nanofibers are in a range of 0.1˜2 μm, and a membrane in the form of a large number of pores may preferably have the pore size of 3 μm or less, and the porosity that is set to 20 to 90%.

The functional membrane 100 is preferably used alone or may be laminated with a non-woven fabric to reinforce the strength. The non-woven fabric may use, for example, any one of a non-woven fabric made of PP/PE fibers of a dual structure in which PE is coated on the outer periphery of a PP fiber as a core, a polyethylene terephthalate (PET) non-woven fabric made of PET fibers, and a non-woven fabric made of cellulose fibers.

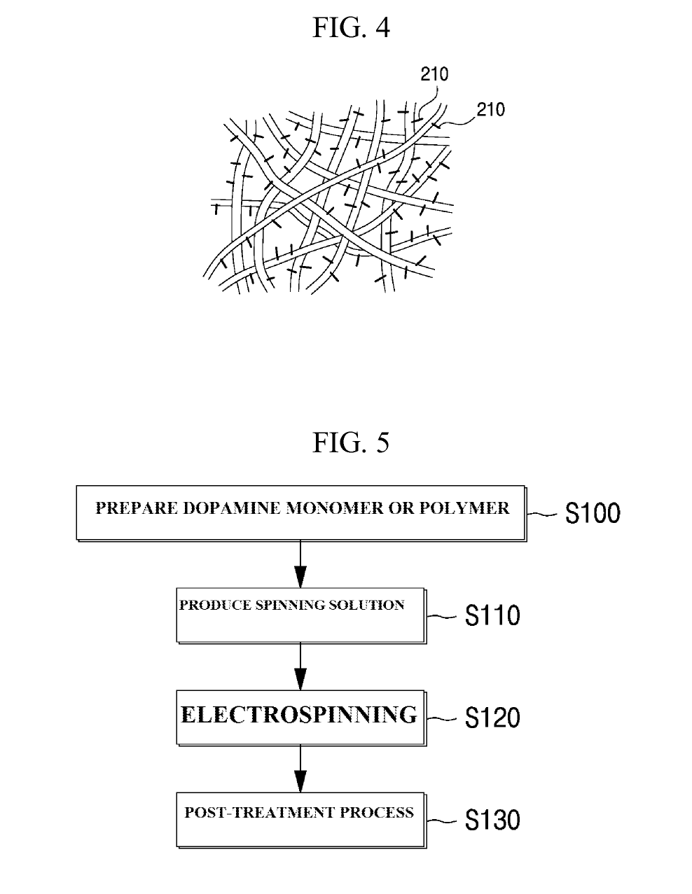

FIG. 3 is a schematic sectional view for explaining a functional membrane according to a second embodiment of the present invention, and FIG. 4 is a schematic view illustrating a state in which functional groups are attached to nanofibers of a functional membrane according to the second embodiment of the present invention.

Referring to FIG. 3, a functional membrane 200 according to the second embodiment of the present invention is configured by comprising a nanofiber web that is formed by accumulating nanofibers that are formed by electrospinning a spinning solution that is produced by mixing a dopamine monomer or polymer, a solvent and a polymer material, and is formed of a plurality of pores., in which functional groups 210 are attached to the nanofibers.

In other words, as shown in FIG. 4, the functional groups 210 are attached to the nanofibers.

The functional groups 210 attached to the nanofibers of the nanofiber web can be formed by a post-treatment process such as UV irradiation, plasma treatment, acid treatment and base treatment, after forming a nanofiber web containing a dopamine monomer or polymer.

Since the functional groups 210 are attached to the functional membrane 200 according to the second embodiment of the present invention, it is possible to make composite dopamine that is formed by adding attraction charges to nanofibers.

That is, since the functional groups 210 is possible to perform the function for adsorbing heavy metals, bacteria, and viruses, with negative functional groups such as SO₃H⁻, or positive functional groups such as NH₄⁺, the functional membrane 200 according to the second embodiment of the present invention is advantageous to filter out heavy metals, bacteria, and viruses contained in treatment water by allowing the treatment water to pass through.

The functional membrane 100 according to the first embodiment of the present invention described above has excellent hydrophilic property by dopamine contained in the nanofibers, and has functionality for adsorbing heavy metals and viruses. Then, the functional membrane 200 according to the second embodiment of the present invention has also excellent hydrophilic property by dopamine contained in the nanofibers, wherein negative functional groups or positive functional groups are attached to the dopamine contained in the nanofibers, and has functionality capable of improving filtering efficiency of filtering out heavy metals and viruses by strongly adsorbing the heavy metals and viruses of more kinds than the functional membrane 100 according to the first embodiment of the present invention.

FIGS. 5 to 8 are flowchart views for explaining first to fourth methods of manufacturing the functional membrane according to the second embodiment of the present invention.

The functional membrane according to the second embodiment of the present invention is configured to include a nanofiber web that is formed by accumulating nanofibers containing dopamine and to which functional groups are attached and is formed of a plurality of pores. Thus, the functional membrane according to the second embodiment of the present invention can be implemented by using any one of first to fourth manufacturing methods to be described later according to the present invention.

Referring to FIG. 5, in the case of a first manufacturing method according to the second embodiment of the present invention, a dopamine monomer or polymer is prepared (S100), and the dopamine monomer or polymer, a solvent and a polymer material are mixed to thus prepare a spinning solution (S110). Then, nanofibers are accumulated and formed by electrospinning the spinning solution, to thus form a nanofiber web with a number of pores, and to then perform a post-treatment process of attaching functional groups to the nanofiber web.

Here, the post-treatment process can be carried out by using one of UV radiation, plasma treatment, acid treatment and base treatment.

In this way, when performing the post-treatment process, the functional groups are attached to unshared electron pairs such as —NH2 or —OH of dopamine, or the functional groups are attached to the benzene ring of dopamine

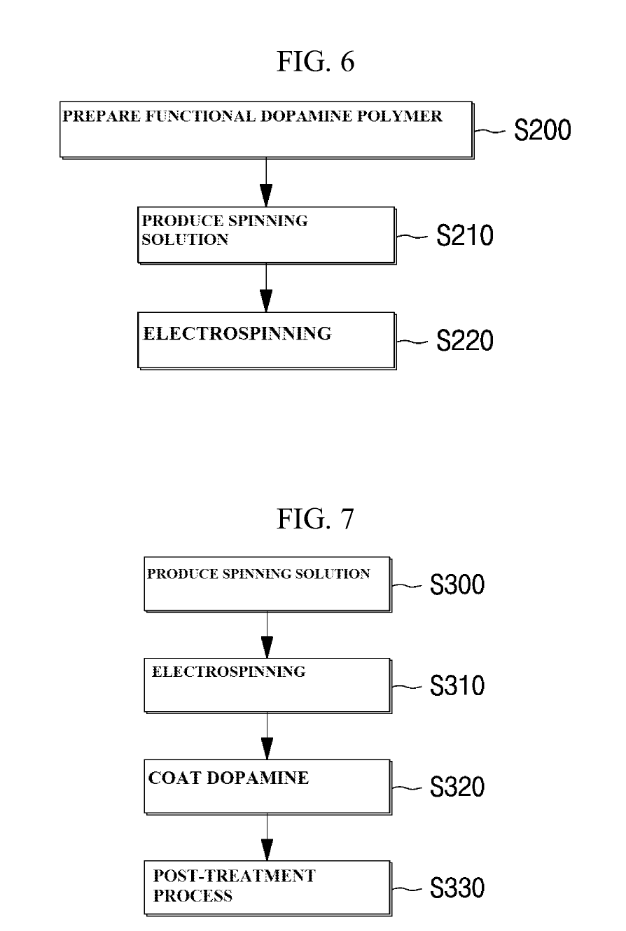

Referring to FIG. 6, in the case of a second manufacturing method according to the second embodiment of the present invention, a process of attaching functional groups to a dopamine polymer is performed to thereby prepare a functional dopamine polymer (S200). Then, the functional dopamine polymer, a solvent, and a polymer material are mixed to prepare a spinning solution (5210). Then, nanofibers are accumulated and formed by electrospinning the spinning solution, to thus form a nanofiber web with a number of pores, and with the functional groups that are attached to the dopamine polymer (S220), to thereby prepare a functional membrane.

Here, a process of attaching functional groups to the dopamine polymer may be any one of UV irradiation, plasma treatment, acid treatment and base treatment.

In addition, referring to FIG. 7, in the case of a third manufacturing method according to the second embodiment of the present invention, a polymer material and a solvent are mixed to prepare a spinning solution (S300). Then, nanofibers are accumulated and formed by electrospinning the spinning solution, to thus form a nanofiber web with a number of pores (S310). Subsequently, dopamine is coated on the nanofiber web (S320), and a post-treatment process is performed to attach functional groups to the nanofiber web (S330).

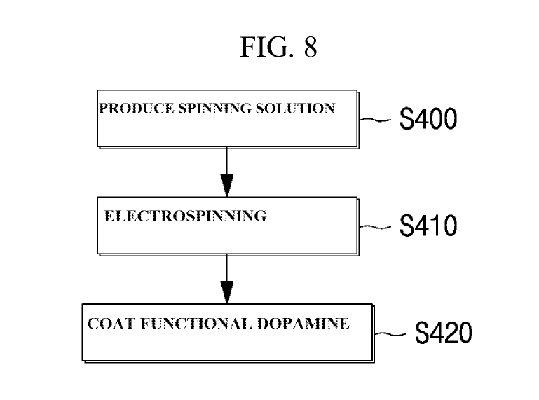

In addition, referring to FIG. 8, in the case of a fourth manufacturing method according to the second embodiment of the present invention, a polymer material and a solvent are mixed to prepare a spinning solution (S400). Then, nanofibers are accumulated and formed by electrospinning the spinning solution, to thus form a nanofiber web with a number of pores (S410). Then, functional dopamine to which functional groups are attached is coated on the nanofiber web (S420).

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

The present invention provides a functional membrane that can enhance filtering efficiency and improve fouling properties, to thereby filter out heavy metals, bacteria and viruses, and a method of manufacturing the same.

1. A membrane comprising a nanofiber web that is formed by accumulating nanofibers that are formed by electrospinning a spinning solution that is produced by mixing a dopamine monomer or polymer, a solvent and a polymer material, and is formed of a plurality of pores.

2. The membrane according to claim 1, wherein functional groups are attached to the nanofibers.

3. The membrane according to claim 2, wherein the functional groups are negative functional groups or positive functional groups.

4. The membrane according to claim 1, wherein the diameters of the nanofibers are in a range of 0.1 to 2 μm, and the sizes of the pores may be 3 μm or less.

5. The membrane according to claim 1, further comprising a non-woven fabric laminated with the nanofiber web.

6. The membrane according to claim 2, further comprising a non-woven fabric laminated with the nanofiber web.

7. The membrane according to claim 3, further comprising a non-woven fabric laminated with the nanofiber web.

8. The membrane according to claim 4, further comprising a non-woven fabric laminated with the nanofiber web.

9. A method of manufacturing a membrane, the method comprising the steps of:
preparing a spinning solution that is produced by mixing a dopamine monomer or polymer, a solvent and a polymer material;
forming a nanofiber web that is formed by accumulating nanofibers that are formed by electrospinning the spinning solution and is formed of a plurality of pores; and
performing a post-treatment process of attaching a functional group to the nanofiber web.

10. A method of manufacturing a membrane, the method comprising the steps of:
preparing a spinning solution that is produced by mixing a polymer material and a solvent;
forming a nanofiber web that is formed by accumulating nanofibers that are formed by electrospinning the spinning solution and is formed of a plurality of pores;
coating dopamine on the nanofiber web; and
performing a post-treatment process of attaching a functional group to the nanofiber web.

11. The method of claim 9, wherein the post-treatment process is any one of UV radiation, plasma treatment, acid treatment and base treatment.

12. The method of claim 10, wherein the post-treatment process is any one of UV radiation, plasma treatment, acid treatment and base treatment.

13. A method of manufacturing a membrane, the method comprising the steps of:
preparing a functional dopamine polymer by performing a process of attaching a functional group to the dopamine polymer;
preparing a spinning solution that is produced by mixing the functional dopamine polymer, a solvent and a polymer material; and
forming a nanofiber web that is formed by accumulating nanofibers that are formed by electrospinning the spinning solution and is formed of a plurality of pores, wherein a functional group is attached to the nanofiber web.
